(19) United States
(12) Patent Application Publication
(10) Pub. No.: US 2006/0221994 A1
(43) Pub. Date: Oct. 5, 2006

(54) Method for allocating slot for synchronous Ethernet service in Residential Ethernet system

(75) Inventors: Jae-Hun Cho, Seoul (KR); Jong-Ho Yoon, Goyang-si (KR); Sang-Ho Kim, Hwaseong-si (KR); Kwan-Soo Lee, Seoul (KR); Yun-Je Oh, Yongin-si (KR); Jun-Ho Koh, Suwon-si (KR); Hye-Jin Nam, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/395,492

(22) Filed: Mar. 31, 2006

(30) Foreign Application Priority Data
Apr. 4, 2005 (KR) 2005-28251

(51) Int. Cl. H04L 12/43

(52) U.S. Cl. 370/458

(57) ABSTRACT

A method for allocating slots for a synchronous Ethernet service in a Residential Ethernet system includes the steps of: receiving requests for synchronous Ethernet services from terminals requiring the synchronous Ethernet services; calculating a number of slots for each synchronous Ethernet service, and allocating slots for each terminal based on the calculated number of slots; transmitting information about the allocated slots through at least one Residential Ethernet switch; and receiving acknowledgement signals from the terminals in response to the allocated slot information and providing the synchronous Ethernet services using the allocated slots.

### CLAIM OF PRIORITY

This application claims the benefit under 35 U.S.C. 119(a) of an application entitled “Method For Allocating Slot For Synchronous Ethernet Service In Residential Ethernet System,” filed in the Korean Intellectual Property Office on Apr. 4, 2005 and assigned Serial No. 2005-28251, the entire contents of which are incorporated herein by reference.

### BACKGROUND OF THE INVENTION

1. Field of the Invention

The present invention relates to Residential Ethernet, and more particularly to a method for allocating slots for a synchronous Ethernet service in a Residential Ethernet system.

2. Description of the Related Art

Ethernet is the most widely used local area network technology and is defined as a standard by an Institute of Electrical and Electronics Engineers (IEEE) 802.3.

According to the conventional Ethernet protocol, since competitive access is accomplished by means of a carrier sense multiple access/collision detect (CSMA/CD) protocol stipulated in an IEEE 802.3, a service frame of an upper layer is converted to an Ethernet frame and must maintain an inter frame gap (IFG) for transmission of Ethernet frames. In this case, upper service frames are transmitted according to the sequence of generation thereof regardless of the type thereof. That is, the Ethernet is a technology generally used when data are transmitted using a plurality of terminals or users.

Such Ethernet has been known to be insufficient for transmitting a moving image or voice data due to transmission delays, because the Ethernet employs the CSMA/CD scheme in which every Ethernet frame is given the same priority during transmission.

However, recently, as the transmission of moving images and voice data susceptible to transmission delay has gradually increased and their relative importance in data transmission has become greater, various methods have been proposed for removing such a problem caused by the transmission delay.

IEEE 802.3p is one scheme conventionally-proposed in order to reduce time delay in the Ethernet. According to the IEEE 802.3p, classification of service (COS) is allocated to data such as multimedia data, to which priority is given. The IEEE 802.3p scheme provides a slightly improved effect with respect to time delay by allocating a priority to multimedia data or the like to be transmitted, as compared with the conventional IEEE 802.3 Ethernet scheme. However, since the IEEE 802.3p scheme does not employ a procedure of requiring and allocating a bandwidth for each data, a bandwidth manager for managing allocation of a bandwidth is required, thereby increasing the size of a jitter buffer for such bandwidth management.

Residential Ethernet is another conventionally-proposed transmission scheme, in which synchronous data and asynchronous data are discretely transmitted during one transmission cycle. According to the Residential Ethernet, slots of the same size are respectively allocated to synchronous data, so that sub-synchronous frames having the same size are constructed and transmitted.

FIG. 1 is a view illustrating the structure of a transmission cycle in a conventional Residential Ethernet.

The conventional Residential Ethernet has a transmission cycle 10 of 125 μsec, which includes an asynchronous frame section 110 for transmission of asynchronous data and a synchronous frame section 100 for transmission of synchronous data.

In detail, the synchronous frame section 100 for transmission of synchronous data contains data having the highest priority in the transmission cycle. According to a proposal currently being discussed, the synchronous frame section 100 includes sub-synchronous frames 101, 102, and 103, each of which consists of 738 bytes. Note that the proposal being currently discussed may change. Also, the asynchronous frame section 110 for transmission of asynchronous data includes sub-asynchronous frames 111, 112, and 113, each of which have a variable size.

FIG. 2 is a view illustrating the structure of a sub-synchronous frame included in a transmission cycle of the conventional Residential Ethernet.

In the conventional Residential Ethernet, a sub-synchronous frame includes an Ethernet header 21, a synchronous header 22, a header check sequence (HCS) field 23, a synchronous data slot field 24, and a frame check sequence (FCS) field 25. The Ethernet header 21 consists of 22 octets and contains header information including type information, a destination address, and a source address of a relevant Ethernet frame. The synchronous header 22 consists of 32 bytes and contains synchronous frame information, such as synchronization state information, frame count information, and cycle count information. The HCS field 23 is used to check header information. The synchronous data slot field 24 consists of 768 bytes, and includes synchronous Ethernet data to be transmitted, which are contained in 192 4-byte synchronous data slots. The FCS field 25 is used to detect a transmission error.

Also, the synchronous data slot field 24 consists of a set of 4-byte data slots 241 and 242, so that each of synchronous Ethernet data is divided into data slots of 4 bytes and is then transmitted.

In this case, when synchronous Ethernet data are transmitted from a server to each user, the synchronous data slot field 24 contains synchronous Ethernet data for all users in the form of slots. Therefore, synchronous Ethernet data are transmitted to the users in a multicast scheme, rather than a unicast scheme, so that each user terminal must process data for the user terminal itself according to data slots.

A destination address included in the Ethernet header 21 is a destination address representing an Ethernet switch for final routing, rather than a destination address of each Ethernet synchronous data. Therefore, the destination address included in the Ethernet header 21 differs from each destination address of Ethernet synchronous data allocated to each user.

As described above, according to the Residential Ethernet, data are allocated to data slots of a sub-synchronous frame and then transmitted, so that a bandwidth is efficiently utilized when a synchronous frame is transmitted. In other words, when data occupying a predetermined bandwidth are transmitted as one packet, an overhead is required for each packet. Accordingly, the amount of overheads increases, so that a proportion of transmission data in the bandwidth is reduced. However, if a plurality of data are transmitted as one packet by using slots, the bandwidth can be efficiently utilized. Particularly, such a phenomenon appears more remarkably when data occupying a smaller port of bandwidth is transmitted.

When such Residential Ethernet is realized, a procedure for reserving, allocating, transmitting, exchanging, and dividing slots is required in order to transmit Ethernet synchronous data. However, any technology for reservation, exchange, and division of slots has not yet been proposed with respect to the Residential Ethernet, so the development thereof is required.

### SUMMARY OF THE INVENTION

Accordingly, the present invention has been made to meet the above-mentioned requirement and provides additional advantages, by providing a method for allocating slots for a synchronous Ethernet service in a Residential Ethernet system, in which an intermediate node of the Residential Ethernet system allocates and reserves slots based on a bandwidth when a predetermined terminal requests synchronous data in the Residential Ethernet system.

In accordance with one aspect of the present invention, there is provided a method for allocating slots for a synchronous Ethernet service in a Residential Ethernet system. The method includes the steps of: receiving requests for synchronous Ethernet services from terminals requiring the synchronous Ethernet services; calculating a number of slots for each synchronous Ethernet service, and allocating slots for each terminal based on the calculated number of slots; transmitting information about the allocated slots through at least one Residential Ethernet switch; and receiving acknowledgement signals from the terminals in response to the allocated slot information and providing the synchronous Ethernet services using the allocated slots.

### BRIEF DESCRIPTION OF THE DRAWINGS

The above features and advantages of the present invention will be more apparent from the following detailed description taken in conjunction with the accompanying drawings, in which:

FIG. 1 is a view illustrating the structure of a transmission cycle in a conventional Residential Ethernet;

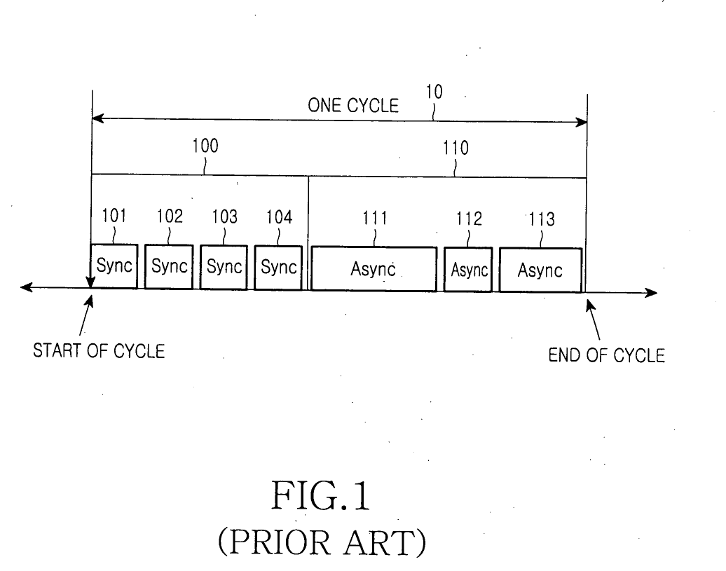

FIG. 2 is a view illustrating the structure of a sub-synchronous frame included in a transmission cycle of the conventional Residential Ethernet;

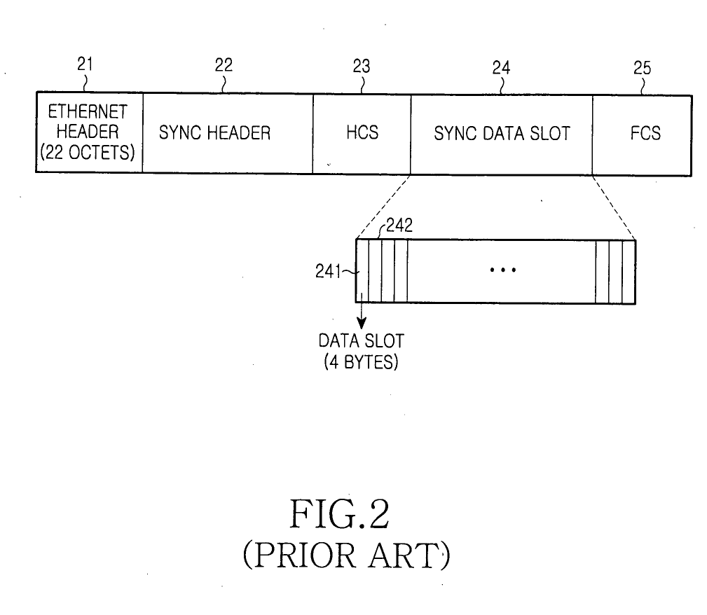

FIG. 3 is a view illustrating a procedure of processing slots in a Residential Ethernet system according to an embodiment of the present invention; and

FIG. 4 is a view illustrating the structure of a Residential Ethernet control packet for transmission of slot information according to an embodiment of the present invention.

### DETAILED DESCRIPTION

Hereinafter, an embodiment of the present invention will be described with reference to the accompanying drawings. It is to be noted that the same elements are indicated with the same reference numerals or symbols throughout the drawings. For the purposes of clarity and simplicity, a detailed description of known functions and configurations incorporated herein will be omitted as it may obscure the subject matter of the present invention.

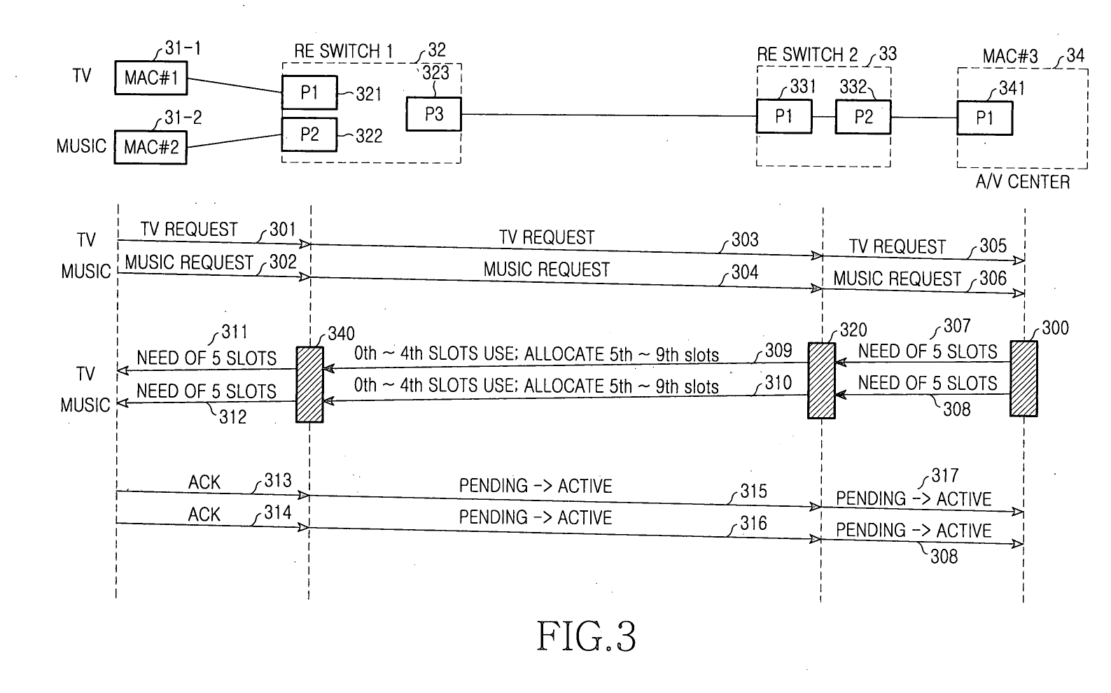

FIG. 3 illustrates a procedure of processing slots in a Residential Ethernet system according to an embodiment of the present invention.

As shown, the Residential Ethernet system includes Residential Ethernet switches 32, 33, and 34 for providing and transmitting service, and terminals 31-1 and 31-2 for requesting and receiving the service.

In detail, the Residential Ethernet switches include a headend apparatus 34 (which is an A/V center in this embodiment of the present invention) for providing a Residential Ethernet service, and a plurality of Residential Ethernet switches 32 and 33 for allocating ports and routing slots in order to transmit the Residential Ethernet service provided by the headend apparatus 34 to the terminals 31-1 and 31-2. In operation, the terminals 31-1 and 31-2 requests synchronous data, receives relevant data through a slot allocated according to the request, and transmits an acknowledgement signal in response to the reception of the relevant data.

A detailed operation of the Residential Ethernet system having the above-mentioned construction will now be described.

First, each of the terminals 31-1 and 31-2 requests a synchronous service based on Residential Ethernet (steps 301 and 302). Herein, according to an embodiment of the present invention, the terminals 31-1 and 31-2 are a TV 31-1 and a music player 31-2, thus request a TV broadcasting signal and music data, respectively.

A first Residential Ethernet switch 32, which has received these synchronous service request signals through input ports 321 and 322, respectively, outputs the synchronous service request signals through an output port 323 (steps 303 and 304). The synchronous service request signals, having been transmitted from the output port 323 of the first Residential Ethernet switch 32, are transmitted to the AV center 34, which is a headend apparatus for providing a synchronous Ethernet service, via the second Residential Ethernet switch 33 (steps 305 and 306).

The AV center 34 calculates bandwidths for the requests of synchronous Ethernet service, and transmits information about the number of slots and allocation of the slots, which are obtained by the calculation (steps 307 and 308).

The slot allocation information of the AV center 34 may be expressed as a slot routing table of Table 1.

TABLE 1

| | | | Number of | Slot | Allocation | Frame |
|---|---|---|---|---|---|---|
| Session | MAC | Port | Slot | Position | State | Number |
| 1 | 1 | 1 | 5 | 0˜4 | P | 1 |
| 1 | 2 | 1 | 2 | 5˜6 | P | 1 |

Referring to Table 1, the information for slot allocation of the Residential Ethernet switches 32, 33, and 34 includes session information, MAC information, port information, slot number information, slot position information, allocation state information, and frame number information. Herein, the session information is used to distinguish sessions for slot allocation. Referring to Table 1, each session information has a value of “1”, which represents that the operations are performed during the same session. That is, this value represents transmission of two pieces of information, which should be synchronized with each other.

The MAC information represents the MAC of a relevant terminal. That is, the MAC information has a value of “1” for representing the MAC of the TV 31-1 and a value of “2” for representing the MAC of the music apparatus 31-2.

The port information represents an output port 341 of the AV center 34. Since the AV center 34 has only one output port as shown in FIG. 3, the port information always has the same value in Table 1.

The slot number information represents information about the number of slots, which is calculated by the AV center 34 for the synchronous Ethernet services requested by the terminals 31-1 and 31-2. Referring to Table 1, 5 slots are allocated for the TV and 2 slots are allocated for the music apparatus.

The slot position information represents the positions of the slots, which have been allocated based on the slot number information. Referring to Table 1, 0^{th} to fourth slots are allocated for the TV 31-1, and fifth and sixth slots are allocated for the music apparatus 31-2.

The allocation state information represents information about a current allocation state of corresponding slots, and it is expressed as “Pending” for a packet in the process of transmitting allocation information from the headend apparatus 34 to the terminals 31-1 and 31-2 for slot allocation. When each terminal 31-1 or 31-2 allows such allocation and notifies the AV center 34, which is a headend apparatus, that allocation has been achieved, the allocation state information is changed to “Active” from “Pending”. In a current state 300 in which relevant slots are allocated but there is no transmitted data, the allocation state information has a value of “P” representing “Pending”.

The frame number information is used to represent a frame number containing data transmitted from the headend apparatus. According to an embodiment of the present invention, the transmitted data include image information for the TV 31-1 and sound information for the music apparatus 31-2, so that the frame number information represents a frame number containing the image information and the sound information. Referring to Table 1, the image information and the sound information are contained in the first frame of every cycle (i.e. every super-frame).

The AV center 34, which is a headend apparatus, transmits such slot allocation information to the second Residential Ethernet switch 33 (steps 307 and 308), so that the second Residential Ethernet switch 33 can allocate corresponding slots for synchronous Ethernet service for the terminals 31-1 and 31-2.

The second Residential Ethernet switch 33, which receives the slot allocation information as described above, constructs a new slot routing table.

Table 2 shows an example of a slot routing table constructed by the second Residential Ethernet switch 33.

TABLE 2

| | | | Number | Slot | | Frame |
|---|---|---|---|---|---|---|
| Session | MAC | Port | of Slot | Position | Allocation | Number |
| 1 | 1 | 1 | 5 | 5˜9 | P | 1 |
| 1 | 2 | 1 | 2 | 10˜11 | P | 1 |
| X | 3 | 2 | X | X | X | X |

Note that the slot routing table shown in Table 2 has information similar to that of Table 1. However, the second Residential Ethernet switch 33 has two ports. The first port of the second Residential Ethernet switch 33 is connected to the first Residential Ethernet switch 32 that is connected to the terminals 31-1 and 31-2, and the second port of the second Residential Ethernet switch 33 is connected to the AV center 34, which are expressed by port information.

Also, the MAC of the AV center 34 is expressed as “3”, so as to represent each apparatus.

The slot position information in table 2 has values different from that of the slot position information in the table 1 constructed by the AV center 34. That is, when the slots indicated by information transmitted from the AV center 34 are currently in use, the same number of slots are allocated from other slot position. Referring to Table 2, fifth to ninth slots are allocated for the TV 31-1, and tenth and eleventh slots are allocated for the music apparatus 31-2.

The remaining information in Table 2 is same as that of Table 1. Since there is no data transmitted from the second Residential Ethernet switch 33 to the AV center, information about a slot thereof does not exist and is expressed as “X” in Table 2.

Information about slots allocated by the second Residential Ethernet switch 33, as described above, is transmitted to the first Residential Ethernet switch 32 (steps 309 and 310).

The first Residential Ethernet switch 32, which has received the slot allocation information, as described above, constructs a new slot routing table.

Table 3 shows an example of a slot routing table constructed by the first Residential Ethernet switch 32.

TABLE 3

| | | | Number | Slot | | Frame |
|---|---|---|---|---|---|---|
| Session | MAC | Port | of Slot | Position | Allocation | Number |
| 1 | 1 | 1 | 5 | 0˜4 | P | 1 |
| 1 | 2 | 2 | 2 | 5˜6 | P | 1 |
| X | 3 | 3 | X | X | X | X |

Note that the slot routing table shown in Table 3 has information similar to that of Table 2. However, the first Residential Ethernet switch 32 has three ports. The first port 321 of the first Residential Ethernet switch 32 is connected to the TV 31-1, the second port 322 thereof is connected to the music apparatus 31-2, and third port 323 thereof is connected to the second Residential Ethernet switch 33, which are expressed by port information.

The slot position information in table 3 has values different from those of the slot position information in the table 2 constructed by the second Residential Ethernet switch 33. That is, when the slots indicated by the slot position information generated from the AV center 34 and transmitted through the second Residential Ethernet switch 33 are not currently in use, the slots are allocated according to the slot position information of the AV center 34. Referring to Table 3, 0^{th} to fourth slots are allocated for the TV 31-1, and fifth and sixth slots are allocated for the music apparatus 31-2.

The remaining information in Table 3 is same as that of Table 2. Since there is no data transmitted to the AV center, information about a slot thereof does not exist, and is expressed as “X” in Table 3.

Information about slots allocated by the first Residential Ethernet switch 32, as described above, is transmitted to the terminals 31-1 and 31-2 (steps 311 and 312).

When the terminals 31-1 and 31-2 detects the slot allocation information and outputs an ACK signal in response to the received slot allocation information (steps 313 and 314), the Residential Ethernet switches 32 and 33 and headend apparatus 34 change allocation information of each slot routing table from “Pending” to “Active” (steps 315 to 318). Such a change of allocation information indicates that a slot allocation operation has been achieved. When such information is completed, the AV center 34, which is a headend apparatus, starts providing synchronous Ethernet services using the allocated slots.

In this case, although the terminals 31-1 and 31-2 have different MAC addresses, the destination address (DA) of the Ethernet header is defined as a multicast address since the services are provided to the terminals through one sub-synchronous frame.

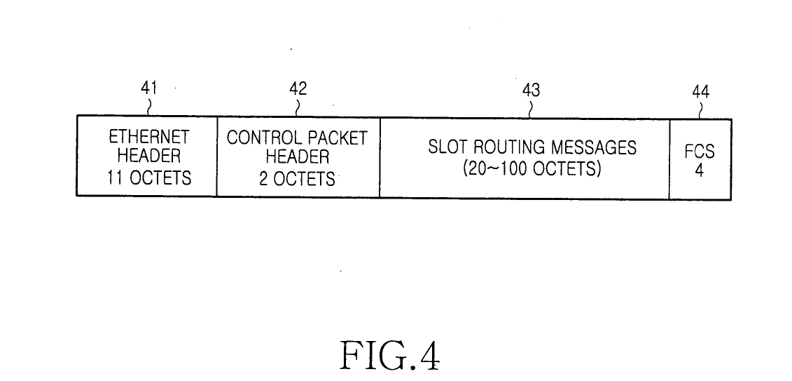

FIG. 4 is a view illustrating the structure of a Residential Ethernet control packet for transmission of slot information according to an embodiment of the present invention.

The Residential Ethernet control packet for transmission of slot information includes 22-byte Ethernet header 41, 2-byte control packet header 42, 20-byte to 100-byte slot routing message 43, and 4-byte frame check sequence (FCS) 44 for checking a transmission error.

The Residential Ethernet control packet, which is defined as described above, includes information about the above-mentioned slot routing table for slot allocation in the slot routing message 43 of the Residential Ethernet control packet. The control packet header 42 includes version information and a reserved area.

According to the present invention as described above, a slot allocation procedure for a Residential Ethernet system is provided, so that the Residential Ethernet system can be efficiently achieved.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for allocating slots for a synchronous Ethernet service in a Residential Ethernet system, the method comprising the steps of:
a) receiving requests for synchronous Ethernet services from a plurality of terminals;
b) calculating a number of slots for each of the synchronous Ethernet services and allocating slots for each terminal based on the calculated number of slots;
c) transmitting information about the allocated slots through at least one Residential Ethernet switch; and
d) receiving acknowledgement signals from the terminals in response to the allocated slot information and providing the synchronous Ethernet services using the allocated slots.

2. The method as claimed in claim 1, wherein, in step d), a destination address (DA) of a packet for the synchronous Ethernet service is a multicast address for the terminals.

3. The method as claimed in claim 1, wherein the slot information is provided in a form of a slot routing table.

4. The method as claimed in claim 3, wherein the slot routing table includes a session information area for representing whether operations are performed in an equal session; a MAC information area for representing a MAC address of a node to which a slot is allocated; a port information area for representing information about a port of a node which creates the slot routing table; a slot number information area for representing a number of slots allocated for the requested synchronous Ethernet service; a slot position information area for representing positions of slots which are expressed by the slot number information area; an allocation state information area for representing a current state of each of the allocated slots; and a frame number information area for representing a position of a frame, which carries data for the synchronous Ethernet service.

5. The method as claimed in claim 4, wherein the slot routing table is reformed by at least one Residential Ethernet switch.

6. The method as claimed in claim 5, wherein, in a slot routing table reformed by the Residential Ethernet switch, a value of the slot position information area is changed.
